(19) United States
(12) Patent Application Publication
(10) Pub. No.: US 2025/0385710 A1
(43) Pub. Date: Dec. 18, 2025

(54) TECHNIQUES FOR POWER LINE COMMUNICATION IN A VEHICLE

(71) Applicant: QUALCOMM Incorporated, San Diego, CA (US)

(72) Inventors: Tien Viet NGUYEN, Bridgewater, NJ (US); Kapil GULATI, Belle Mead, NJ (US); Gene Wesley MARSH, San Diego, CA (US); Qing LI, Princeton Junction, NJ (US); Ahmed Farhan HANIF, Versailles (FR)

(21) Appl. No.: 18/744,081

(22) Filed: Jun. 14, 2024

(51) Int. Cl. H04B 3/54

(52) U.S. Cl. CPC H04B 3/54

(57) ABSTRACT

Aspects of the present disclosure relate to communication systems, and more particularly, to techniques for power line communication (PLC). Some aspects include a method for data communication. The method generally includes: monitoring, via a first device, communications traffic on a power line to receive a first payload originating from a second device and targeted to a third device; generating a data unit including the first payload to relay the first payload to the third device; and sending the data unit on the power line.

### BACKGROUND

### Field of the Disclosure

Aspects of the present disclosure relate to communication systems, and more particularly, to techniques for power line communication (PLC) in a vehicle.

### Description of Related Art

Power line communication (PLC) networks provide an efficient means for data communication using existing power line used to provide electrical power to electronic devices. For example, power lines may be used to provide power to electronic devices from a power source. PLC networks may be implemented in homes, industrial buildings, or as part of vehicles to facilitate data communications. In a home, a PLC network may be used to provide communications between smart devices such as thermostats, televisions, lighting systems, or security cameras using existing infrastructure put in place for providing electrical power. In some cases, a PLC network may be implemented in a vehicle for communication with sensors, actuators, displays, or speakers. PLC networks may be used for many applications but are especially suitable in scenarios where laying new communication cables is difficult or impractical. However, PLC networks face many challenges, such as signal attenuation, noise, and interference.

### SUMMARY

Certain aspects of the present disclosure are directed towards a method for data communication. The method generally includes: monitoring, via a first device, communications traffic on a power line to receive a first payload originating from a second device and targeted to a third device; generating a data unit including the first payload to relay the first payload to the third device; and sending the data unit on the power line.

Certain aspects of the present disclosure are directed towards an apparatus for data communication. The apparatus generally includes a memory and one or more processors coupled to the memory and configured to: monitor, via a first device, communications traffic on a power line to receive a first payload originating from a second device and targeted to a third device; generate a data unit including the first payload to relay the first payload to the third device; and send the data unit on the power line.

Certain aspects of the present disclosure are directed towards a non-transitory computer-readable medium having instructions stored thereon, that when executed by one or more processors, cause the one or more processors to: monitor, via a first device, communications traffic on a power line to receive a first payload originating from a second device and targeted to a third device; generate a data unit including the first payload to relay the first payload to the third device; and send the data unit on the power line.

Other aspects provide: an apparatus operable, configured, or otherwise adapted to perform any one or more of the aforementioned methods and/or those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 illustrates an example power line communication (PLC) network for a vehicle, in accordance with certain aspects of the present disclosure.

FIG. 6 illustrates an example carrier sense multiple access (CSMA) communication protocol, in accordance with certain aspects of the present disclosure.

FIG. 7 is a table illustrating example characteristics of different robust modes, in accordance with certain aspects of the present disclosure.

FIG. 8 illustrates an example relay device receiving a payload from an originating device, in accordance with certain aspects of the present disclosure.

FIG. 9 illustrates an example relay device storing received payloads and selecting a subset of the payloads for relaying, in accordance with certain aspects of the present disclosure.

FIG. 10 shows an example of a method of data communication at a controller associated with a communication device.

FIG. 11 depicts aspects of an example communications device.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Aspects of the present disclosure provide apparatuses, methods, processing systems, and computer-readable mediums for device to techniques for communicating using a power line communication (PLC) network. Specifically, certain aspects provide communication techniques for PLC networks in vehicles. Small packet sizes normally found in vehicular sensors are not well suited for PLC or physical layer (PHY) feedback, which is subject to impulsive noise (e.g., pulse occurrences) and background noise (e.g., non-white noise) that may occur during certain vehicle operations such as braking, cruising, acceleration, or ignition.

Some electronic devices may be powered using a power line cable between electronic devices and one or more power sources. The powered devices may also have to be controlled by a controller. To do so, a separate cable for communication may be coupled between the electronic devices and the controller. In some cases, instead of using a separate cable for communication, the power line cable may be used to control and communicate with the electronic devices. A power line communication (PLC) device (e.g., chip) may be used to implement the communication across the power line cable of a vehicle, facilitating communication between a controller and various electronic devices such as vehicular sensors. In this manner, a separate cable for communication may be not be used, saving cost and area. However, as described, communications for a vehicle (e.g., reception sensor data) may include small packet sizes that are not suitable for PLC networks, as described.

Some aspects of the present disclosure enable more efficient power line communication in vehicles. For instance, in some aspects, one or more devices (e.g., also referred to herein as relay devices) in a vehicular PLC network may be used to monitor communications traffic on a power line. The relay device may monitor for communications traffic, regardless of whether the communications traffic (e.g., packets) on the power line are targeted to the relay device. Each relay device may implement packet aggregation and duplication (e.g., also referred to as network packet duplication). For example, each relay in the PLC network may duplicate and aggregate the received packet of other devices to be relayed with a packet generated by the relay device. In some implementations, the PLC network may include one or more dedicated relay devices (e.g., devices dedicated for relaying packets from other devices). The relay device (e.g., dedicated relay device) may support tone mapping to improve packet relay efficiency, as described in more detail herein.

In some aspects, the relay device may receive multiple packets and select which packets to relay based on one or more conditions. Selecting which packet to be relayed may be based on which received packet is impacted by impulsive noise and/or has high insertion loss. For example, a relay device may consider factors that may indicate network degradation, based on which the relay device may begin network packet duplication techniques described herein. These factors may include, but are not limited to, a signal strength for PLC below a threshold, network congestion level, the relay device's own packet size (e.g., payload size) being smaller than a threshold (e.g., allowing the relay device to retransmit a payload of another device), or vehicle state (e.g., the vehicle is accelerating or braking resulting in increased noise).

For increased reliability, various robust (ROBO) modes may be implemented that involve using redundancy of encoded bits by means of repetition encoding to increase decoding reliability. The different ROBO modes are described in more detail herein. One of the ROBO modes is referred to as a high speed robust mode (HS-ROBO). Some aspects are directed towards selection of a robust mode for relaying packets. For example, the high speed robust mode may be selected if relayed communications traffic is high. Using high speed robust mode allows the relay device to increase (e.g., double) the amount of data transmitted in the same burst duration, providing for more aggressive relaying. High robust mode may be used when channel conditions (channel quality) are above a threshold, where other robust modes providing greater reliability may be used if the channel conditions are less than or equal to the threshold.

In some aspects, one or more relays may be configured as dedicated relays to implement network packet duplication. The dedicated relays may be more complex and support tone mapping, providing a more efficient relaying operation. In some cases, packets to be exclusive ORed (XORed) with one another to increase decoding efficiency.

Particular aspects of the subject matter described in this disclosure can be implemented to realize one or more of the following potential advantages. In some examples, by using devices on the PLC network to relay packets from other devices, the efficiency of the network is increased, especially for applications that communicate small size packets on the network. That is, extra resources of a data unit may be wasted (e.g., filled with padding bits) when communicating a small packet size. By relaying communications traffic, the extra resources in the data unit may be filled with the payload of other devices. The extra resources are no longer wasted and used to facilitate a more efficiency PLC network communication.

In some aspects, packets to be relayed may be selected based on one or more conditions that indicate degraded network conditions. By relaying only select packets or relaying packets during select time durations with degraded network conditions, computing resources and network overhead may be reduced.

As described, a high robust mode may be selected based on network conditions to provide increased throughput when network traffic increases. As described, the robust mode to be used may be tailored to the channel conditions. For example, the robust mode may be selected so that the robust mode most suitable for the channel conditions are used, increasing communication efficiency. In some cases, decoding efficiency and reliability may be further increased by performing an XOR operation of packets, as described in more detail herein.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

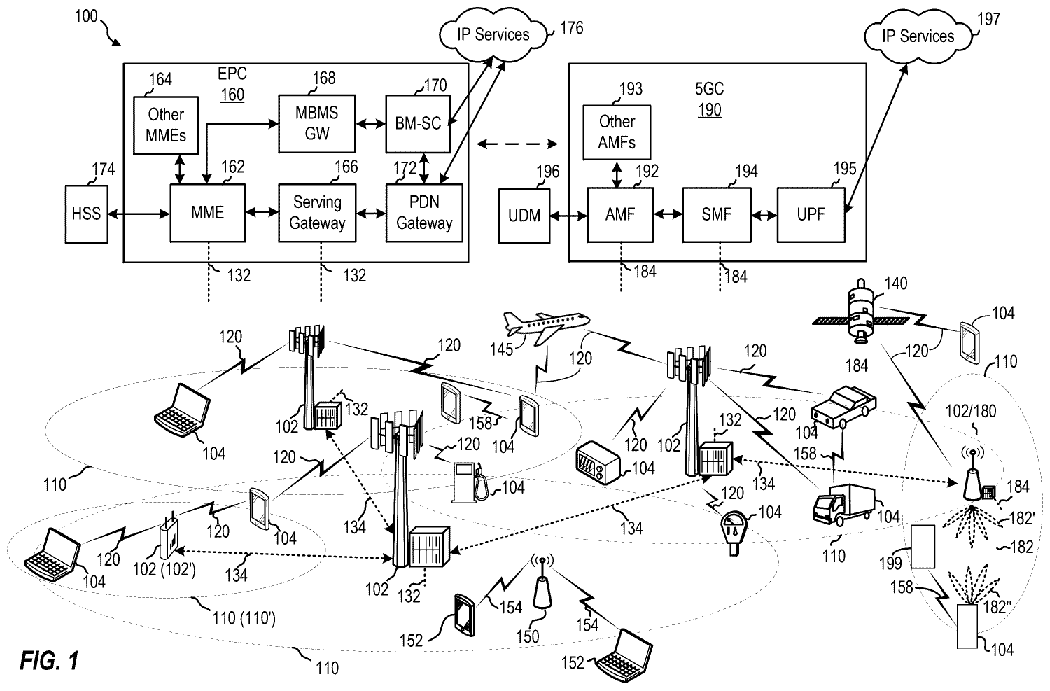

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

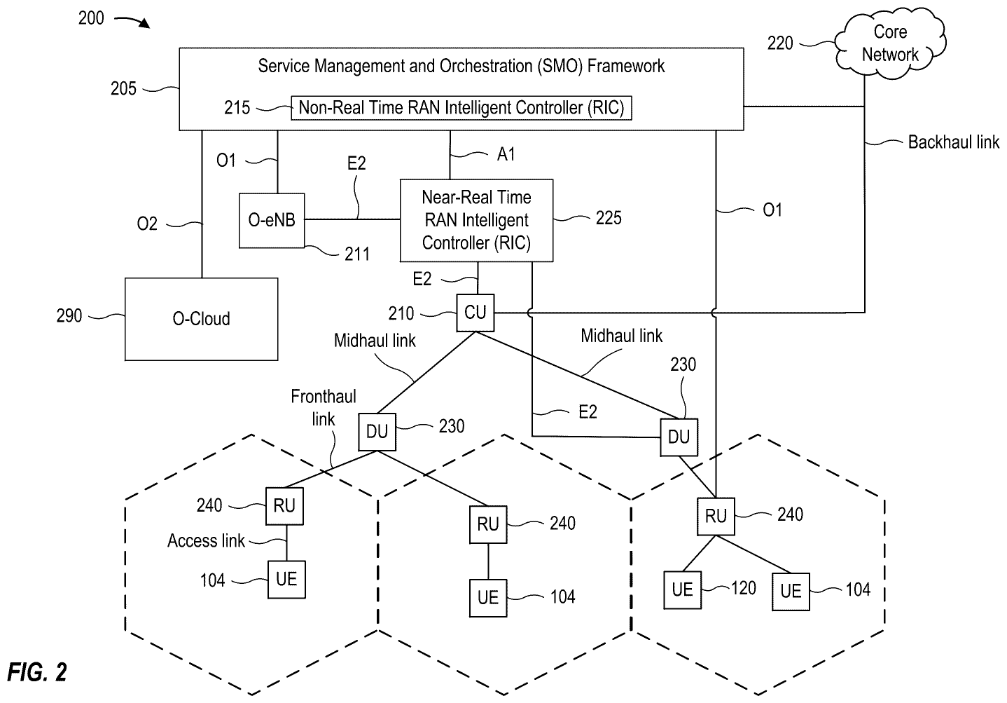

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHZ-7125 MHz, which is often referred to (interchangeably) as “Sub-6 GHz”. Similarly, 3GPP currently defines Frequency Range 2 (FR2) as including 24,250 MHZ-71,000 MHZ, which is sometimes referred to (interchangeably) as a “millimeter wave” (“mmW” or “mm Wave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158 (e.g., a PC5 link). D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multi-cast Service (MBMS) Gateway 168, a Broadcast Multi-cast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multi-cast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

In some aspects, the UE described with respect to FIG. 1 may be any suitable controller or modem for a power line communication (PLC) network in a vehicle. The UE may communicate with a controller 199 associated with an electric grid either through a Uu link or via sidelink (e.g., PC5 link).

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-cNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

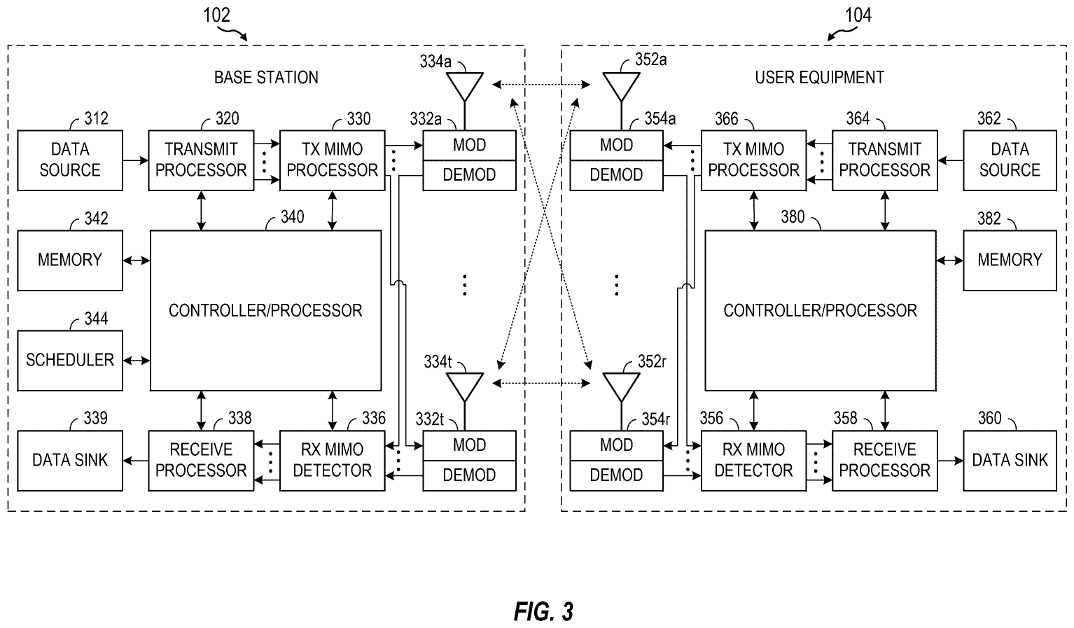

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

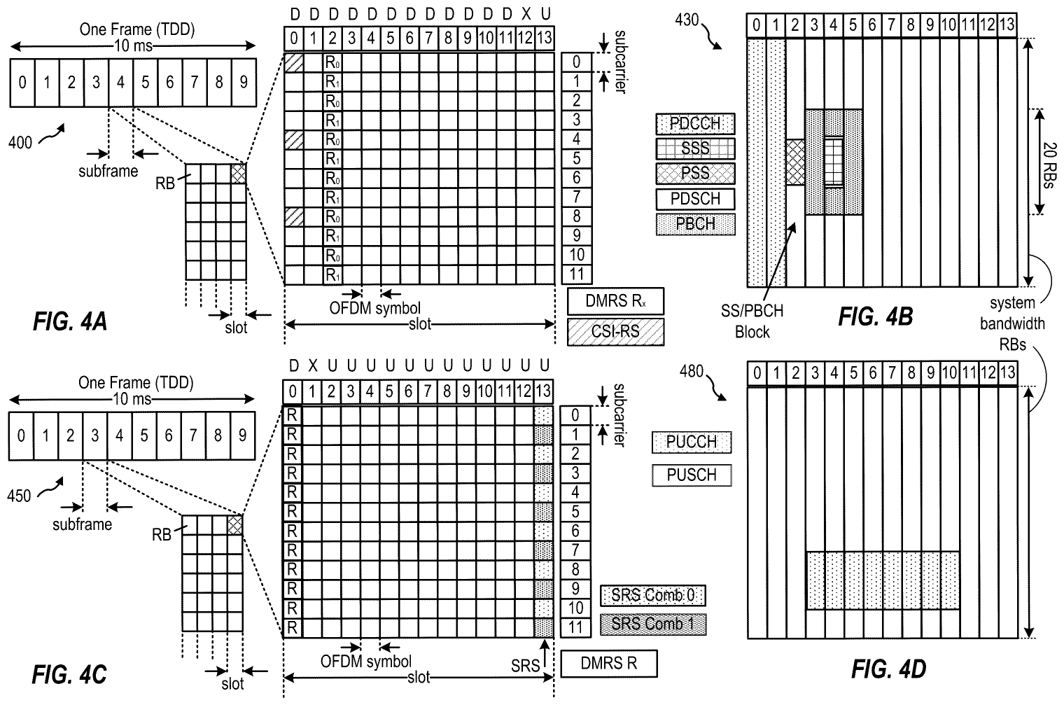

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Techniques for Power Line Communication

Various electronic devices may be powered using a power line cable between electronic devices and one or more power sources. The powered devices may also have to be controlled by a controller using control information or communicate information (e.g., sensor information) with the controller. To do so, a separate cable for communication may be coupled between the electronic devices and the controller. In some cases, instead of using a separate cable for communication, the power line cable may be used to control and communicate with the electronic devices, saving cost and area. For instance, in a home, a television may be plugged into a power line, and the power line may be used to communicate information with the television (e.g., for audio or video streaming) without using a separate communication cable. A power line communication (PLC) device (e.g., chip) may be used to implement the communication across the power line cable. Certain aspects of the present disclosure are directed towards techniques for using PLC for in-vehicle communications.

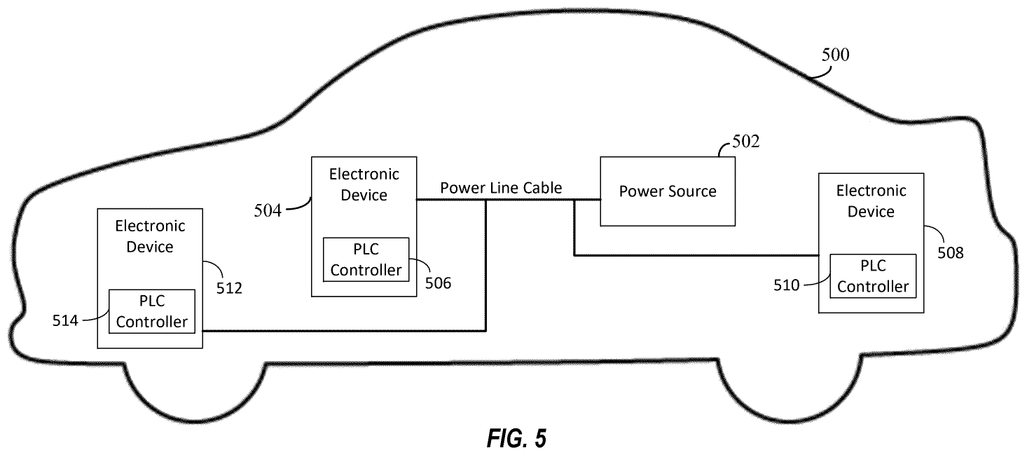

FIG. 5 illustrates an example PLC network for a vehicle 500, in accordance with certain aspects of the present disclosure. As shown, the vehicle 500 may include a power source 502, which may provide power to one or more electronic devices such as electronic devices 504, 508, 512 of the vehicle 500 using a power line cable. For example, an electronic device may be a sensor of the vehicle 500. Each of the electronic devices 504, 508, 512 may include a PLC controller 506, 510, 514, respectively, to control communication using the power line cable. For example, each PLC controller may be coupled (e.g., magnetically coupled using an inductive element or winding) to the power line cable to encode information on the cable for communication.

Some PLC implementations (e.g., in-home PLC) may use a fast-Fourier transform (FFT)-orthogonal-frequency division multiplexing (OFDM) waveform, which provides a high data rate that is especially useful for applications such as video and audio streaming. In some implementations, PLC may use a seven-byte header (e.g., a short protocol data unit (PDU) containing no data payload). To save on cost and simplify implementation, two sizes of code blocks (e.g., 136 bytes or 520 bytes) may be used. Thus, the packet data size may have to be a multiple of these two code block sizes, which may be inefficient when a device only has to communicate a small payload. There is also some physical layer (PHY) overhead. For example, the overhead for PLC may include a sounding PDU for channel estimation (e.g., 136 or 520 bytes), a beacon PDU (e.g., 136 bytes), and a network management PDU.

PLC may also use low frequencies (e.g., 2-3 MHz to 30 MHz with a sampling frequency of about 100 MHZ). In such examples, the sampling rate may be low. The OFDM symbol for PLC may be relatively long (e.g., as compared to an OFDM symbol for third-generation (3G), fourth-generation (4G), or WiFi implementations). For instance, the OFDM symbol may be 35 to 84 milliseconds for PLC (e.g., as compared to 3-7 microseconds for WiFi). A single transmission using PLC with a data payload may be at least 169.76 us plus 48.52 us, where a transmission without a data payload may be at least 169.76 us.

PLC communication may also use carrier sense multiple access (CSMA) to allow for different devices to compete for the medium (e.g., multiple controllers may attempt to communicate across the same power line cable). Using CSMA with the long OFDM symbol for PLC results in a long end-to-end delay (e.g., close to 1 millisecond, but may increase to 10-20 milliseconds depending on the loading of the channel). This long end-to-end delay causes inefficiencies that are especially impactful to implementations that involve frequent communications of small payloads. For example, the smallest payload size for PLC may be 108 bytes, making PLC inefficient for small packet sizes and frequent transmission traffic types that are found in vehicle applications, as described herein.

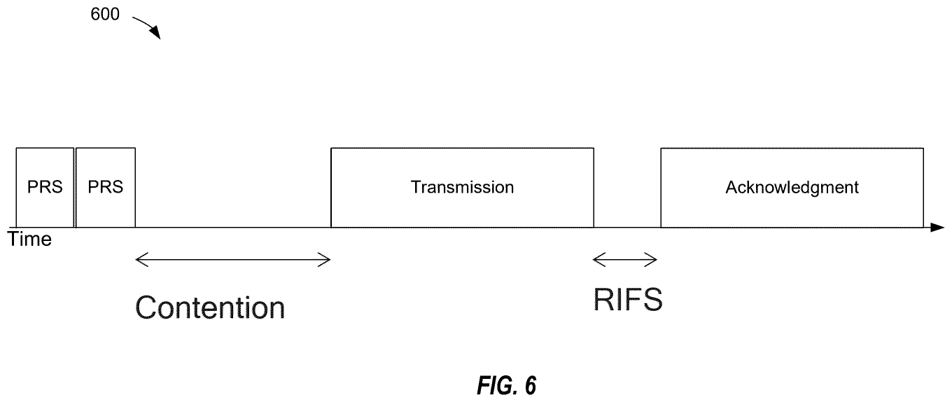

FIG. 6 illustrates an example CSMA communication protocol 600, in accordance with certain aspects of the present disclosure. As shown, the communication protocol 600 may include priority reference signals (PRS), followed by a contention period. After contention, transmission may occur, followed by an acknowledgement (ACK) after a reduced inter-frame space (RIFS). As shown, there may be two PRSs, each indicating two bits to represent four possible priorities for contention. For instance, if a device transmits PRSs indicating a higher priority, other devices may yield during contention to provide the higher-priority device with a greater chance of obtaining the medium for transmission.

Some devices implement a robust OFDM mode (also referred to as ROBO mode) to reduce costs further. For ROBO mode, high data rate transmissions may not be used. Only low data rate coding schemes may be used but with repetitions. For instance, a lower data rate coding scheme (e.g., quadrature phase-shift keying (QPSK)) may be used with multiple code repetitions.

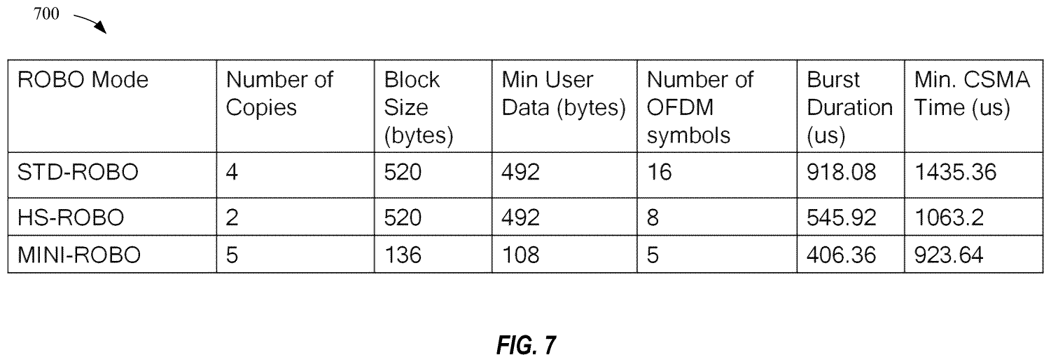

FIG. 7 illustrates a table 700 illustrating various characteristics of different ROBO modes. To increase robustness of communications, various robust (ROBO) modes may be implemented to provide more reliable communications. When a ROBO mode is enabled, the payload bits may be sent to an interleaver to provide redundancy to the encoded bits by means of repetition encoding. Copies of encoded bits may be spread across both frequency and time to increase decoding reliability. A standard ROBO (labeled “STD-ROBO”) mode may use a repetition code of factor four, whereas a high-speed ROBO (labeled “HS-ROBO”) mode may use a repetition code of factor two, providing twice higher data rate. A mini-ROBO (MINIROBO) may provide the highest number of copies which may be suitable for small payloads that can take advantage of highly reliable communication. For example, for a standard ROBO mode, four copies of encoded bits in a data frame may be used (e.g., four code repetitions) with a block size of 520 bytes, a minimum user data of 492 bytes, 16 OFDM symbols, a burst duration of 918.8 us, and a minimum CSMA time of 1435.36 us. For a high speed (HS)-ROBO mode, two copies of encoded bits in a data frame may be used (e.g., two code repetitions) with a block size of 520 bytes, a minimum user data of 492 bytes, 8 OFDM symbols, a burst duration of 545.92 us, and a minimum CSMA time of 1063.2 us. For a mini-ROBO mode (e.g., the most robust mode), five copies of encoded bits may be used (e.g., five code repetitions) with a block size of 136 bytes, a minimum user data of 108 bytes, 5 OFDM symbols, a burst duration of 406.36 us, and a minimum CSMA time of 923.64 us.

PLC noise may include additive colored Gaussian noise but may be treated as additive white Gaussian noise (AWGN) given that ROBO mode of communication spreads the code block evenly in frequency. Noise variance may depend on the location of the device (e.g., the location of the PLC controller or electronic devices in the vehicle). However, a key or critical noise of concern for PLC communication may be impulsive noise. Impulsive noise may result from various transient effects on the PLC system (such as flipping on a switch in a vehicle including in the PLC network). Impulsive noise may be of concern in a vehicle due to various causes of transient effects that may occur more often in a vehicle (e.g., as compared to a home). For example, various switches may be controlled in a vehicle, windows may be rolled up and down, or braking of the vehicle may occur, which may each have transient effects on the PLC. For instance, a pulse may occur during communication with various parameters such as pulse duration, pulse frequency, pulse amplitude, pulse exponential coefficient, intensity, or probability of being an exponential or triangular pulse. These parameters may be impacted by various vehicle operations such as braking, cruising, accelerating, or igniting. One of the key drivers of packet loss (e.g., other than from interference) during vehicle operation may be impulsive noise. Some PDUs may be lost entirely if impacted by more than one pulse.

For less than 500 bytes of payload, using physical layer (PHY) feedback may be inefficient. For example, using PHY feedback may add roughly 300 us of delay (e.g., associated with RIFS and acknowledgment (ACK)/negative acknowledgment (NACK)) per transmission. Retransmission by other devices may be used instead. For example, in some aspects, each device may retransmit a payload from other nearby devices with its own payload, improving reliability with little to no cost as the retransmitting device may have to pad its own payload to the typical code block size of 520 bytes anyway. Some aspects may use network coding to improve the efficiency of this method further.

In some aspects, devices in a vehicular PLC network may monitor communications traffic on the power line cable regardless of whether the device is the target for the communications traffic or not. Each device may monitor the PLC network for payloads from other devices and relay those payloads to improve reliability. For example, referring back to FIG. 5, device 512 may send a payload targeted to device 508. Device 504 may monitor the PLC network and detect the payload from device 512. Device 504 may include the payload from device 512 as part of a payload for device 504 to provide network packet duplication (e.g., payload duplication). Thus, if the original payload from device 512 is lost, the duplicated payload from device 504 may reach device 508, improving network reliability.

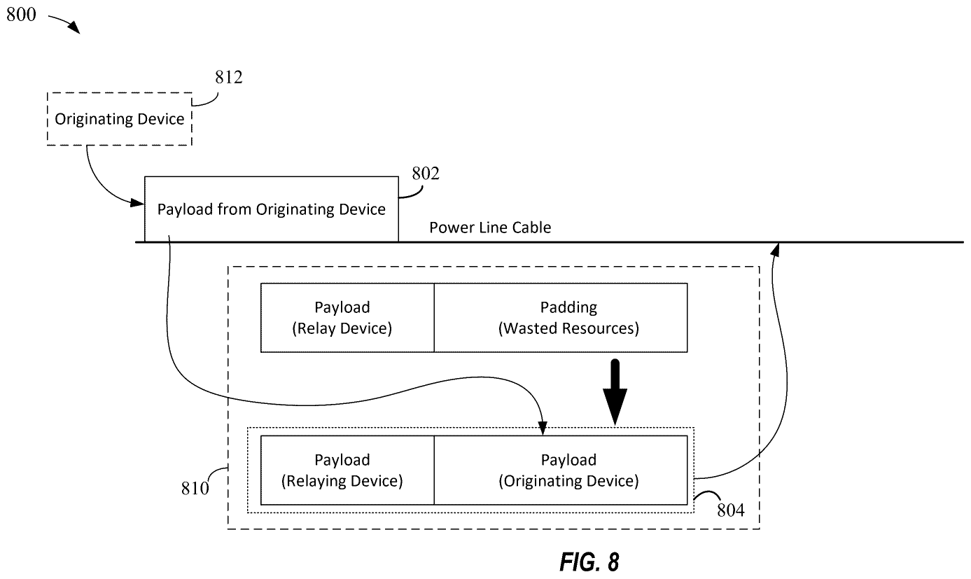

FIG. 8 is a diagram 800 illustrating a relay device 810 receiving a payload 802 from an originating device 812 (e.g., a device from which a payload to be relayed originates) and including the payload as part of a data unit 804 of the relay device, in accordance with certain aspects of the present disclosure. A device may be a relay device at one point in time (e.g., relaying a payload for another device) and an originating device at another point in time (e.g., sending a payload that is relayed by another device).

As previously described, the smallest payload size for PLC may be 108 bytes. A relay device may send a payload that is less than 108 bytes and, thus, may have to pad the payload up to the 108 bytes, which is wasted resources, as shown. Thus, the relay device may monitor for and receive a payload 802 on the power line cable from the originating device. The relay device may then include the payload for the originating device as part of the data unit 804 (e.g., packet) of the relay device in order to use the extra resources available on the data unit (e.g., instead of the extra resources being wasted by padding). The data unit 804 is then sent on the power line cable to provide packet duplication and increase reliability.

The monitoring may be performed in response to one or more conditions being met. For example, the monitoring may be performed based on the relay device detecting a signal strength for PLC below a threshold, network congestion level (e.g., as determined using CSMA historical data), the relay device's own packet size (e.g., payload size) being smaller than a threshold (e.g., allowing the relay device to retransmit a payload of another device), or vehicle state (e.g., the vehicle is accelerating or braking). These conditions may indicate network reliability degradation. Thus, network packet duplication (e.g., packet or payload retransmission) may be enabled to enhance reliability. To enable packet duplication, transmissions may be multi-cast at PHY level. The traffic filtering may be performed at the application layer. In other words, at the application layer, a target device may identify the payload that is intended for the target device. If network packet duplication is done based on vehicle state, then the transmission may be only multi-cast when the vehicle is in the state of interest (e.g., while braking or accelerating).

Certain aspects of the present disclosure have described techniques for duplicating a packet (or payload) from an originating device in a PPDU to be sent via PLC by a relay device. This technique may be referred to as network packet duplication. In some cases, network packet duplication may be used instead of PHY layer feedback, improving PLC efficiency. Network packet duplication uses padded bits in PLC that otherwise would be wasted to provide packet duplication for other devices. Using network packet duplication may eliminate (or at least reduce) the transmit time overhead associated with PHY feedbacks (e.g., around 300 us per feedback). Network pcket duplication also allows for a longer transmission burst, which may amortize the transmit time overhead associated with CSMA.

Configuring a device to receive and relay payloads from other devices may add software complexity and extra memory usage. Thus, some low-cost devices may not be able to support this feature. Although low-cost devices may not monitor and relay payloads from other devices, payloads from low-cost devices may still be relayed by other devices.

When network packet duplication is activated, each relay device may monitor for and receive multiple payloads in a PLC network. The relay device may then choose, from the payloads the relay device received in the past, a subset of the payloads to relay. The relay device may then form PDPU(s) by aggregating its own payload with the payloads to be relayed and multi-cast to other devices in the network.

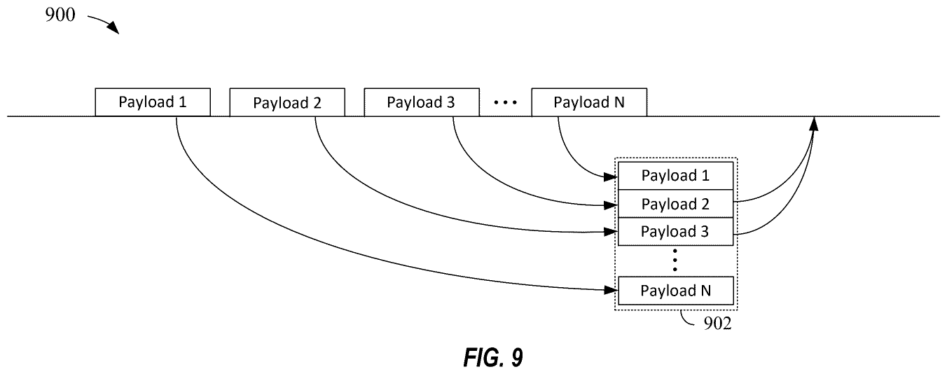

FIG. 9 is a diagram 900 illustrating a relay device 902 storing received payloads and selecting a subset of the payloads for relaying, in accordance with certain aspects of the present disclosure. For instance, the relay device 902 may monitor for and receive payloads 1-N, N being any positive integer. Based on one or more conditions, the relay device may select a subset of the payloads 1-N to be relayed. For example, payloads 2-3 may be chosen and relayed.

A relay device may include a circuit to detect impulsive noise in some aspects. Hence, the device may identify whether a received payload is impacted by impulsive noise. In response, the device may prioritize the payload affected by impulsive noise. The device may select the payload for duplication to prioritize the payload. While the relay device may have received a payload to be relayed, given that the payload was impacted by impulsive noise, other devices (e.g., a target device of the payload) may not be able to decode the payload (e.g., due to a worse insertion loss of the target device).

A relay device may also relay payloads from other originating devices that are connected to the relay device via a direct path, even if the relay device has a high insertion loss. A direct path in the vehicle is a path that does not go through the battery pack. For example, referring back to FIG. 1, device 512 may have a direct path to device 504, but not a direct path to device 508 because the power source 502 (e.g., a battery pack) is coupled to a node of the power line cable between electronic devices 508, 512. A direct path has better insertion loss than an indirect path. Thus, if a relay device has high insertion loss, given that the relay device has a direct path with an originating device, the insertion loss in an indirect path is even worse. Thus, the relay device may prioritize relaying payloads from an originating device to which the relay device has a direct path. A relay device may receive a payload, identify the originating device of the payload based on the transmitter address associated with the payload, and based on whether the path between the relay device and the originating device is a direct path, decide whether to relay that payload.

In some aspects, a relay device may be configured with a list of one or more other devices to support (e.g., relay packets for). The list for each relay device may be configured in the factory. In other words, since power line configuration in a vehicle may be static, the list of devices to be supported by each relay device can be calibrated and configured in the factory. The list may be updated later to account for vehicle-to-vehicle variations.

As described herein, to increase robustness of communications, various robust (ROBO) modes may be implemented to provide more reliable communications. When a ROBO mode is enabled, the payload bits may be sent to an interleaver to provide redundancy to the encoded bits by means of repetition encoding. Copies of encoded bits may be spread across both frequency and time to increase decoding reliability.

In some aspects, when a relay device is relaying payloads for other devices, the relay device may use HS-ROBO instead of STD-ROBO if the amount of relayed communications traffic is high. Using HS-ROBO allows the relay device to double the amount of data to be transmitted in the same burst duration (e.g., since the number of copies of data is half for HS-ROBO as compared to STD-ROBO). By using HS-ROBO, more aggressive relaying may be performed. As a result, more network diversity effects may be achieved at the cost of reducing single-link diversity. In some cases, if channel conditions (channel quality) are below a threshold, payload relaying may use STD-ROBO (e.g., increasing reliability by including more data copies).

In some aspects, one or more devices may be included in the PLC network of the vehicle that are configured as dedicated relays. For instance, some networks may include at least one dedicated device that may be located close to a central processing unit of the network and act as a relay between the central processing unit and other devices. This dedicated relay, being not as numerous as other devices, may be more complex and support tone mapping, providing a more efficient relaying operation. To implement tone mapping, the relay device may identify a tone (e.g., a frequency) that provides a strong signal and low noise. The mapping of tones to signal strength or noise may be pre-identified using sounding operations.

To further enhance the efficiency of relay operations, the payloads to be relayed may be exclusive ORed (XORed) with each other to make use of network coding. That is, if multiple packets are to be relayed, the packets to be relayed may be XORed with each other, increasing the capacity of the network and improving the decoding at a receiver.

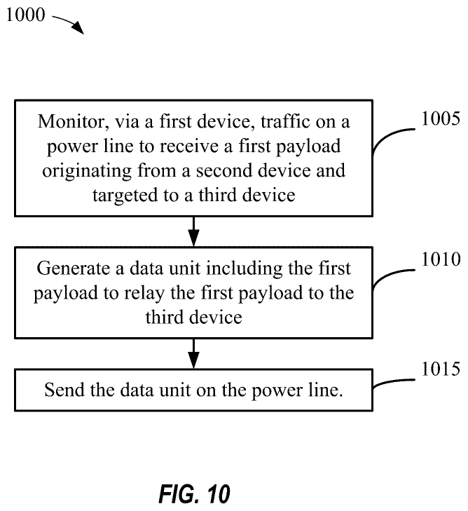

FIG. 10 shows an example of a method 1000 of data communication at a controller associated with a communication device. The communication device may be a first device (e.g., of a vehicle) such as a relay device (device 504, 508, or 512 of FIG. 5).

Method 1000 begins at step 1005 with the first device monitoring communications traffic on a power line to receive a first payload originating from a second device (e.g., of the vehicle) and targeted to a third device (e.g., of the vehicle). In some aspects, the power line is part of a PLC network of a vehicle. In some aspects, the first device may be a dedicated relay device.

In some aspects, the first payload may be one of a plurality of payloads received by the first device. The first device may select, from the plurality of payloads, the first payload to be relayed based on one or more conditions associated with the payload. The one or more conditions may include whether a direct path exists between the first device and the second device. The first device may maintain a list of devices to support for payload relaying, in some cases. The one or more conditions may include whether the second device is part of the list of devices.

At step 1010, the first device generates a data unit including the first payload to relay the first payload to the third device. In some aspects, the first device generates a second payload to be sent on the power line. The data unit may further include the second payload. The second payload may be targeted to a fourth device different than the third device, in some cases.

In some aspects, the communications traffic on the power line is monitored in response to one or more conditions being met. The one or more conditions may include: a signal strength on the power line being below a signal strength threshold; a level of congestion associated with the communications traffic on the power line; whether a size of a payload generated by the first device to be included in the data unit is less than a payload size threshold; or a state of a vehicle including the power line.

The communications traffic on the power line may be monitored to further receive a second payload targeted to the third device or a fourth device. The data unit may also include the second payload. The first device may perform an exclusive OR (XOR) operation on the first payload and the second payload to yield XOR data. Including the first payload and the second payload in the data unit may comprise including the XOR data in the data unit. At step 1015, the first device may send the data unit on the power line.

In some aspects, the first device may select a first robust mode from a plurality of robust modes to send the data unit, the plurality of robust modes being associated with different numbers of code repetitions, wherein the first robust mode has fewer code repetitions than a second robust mode of the plurality of robust modes. The first robust mode may be selected based on a quality of a channel on the power line being greater than a threshold.

### Example Communications Device(s)

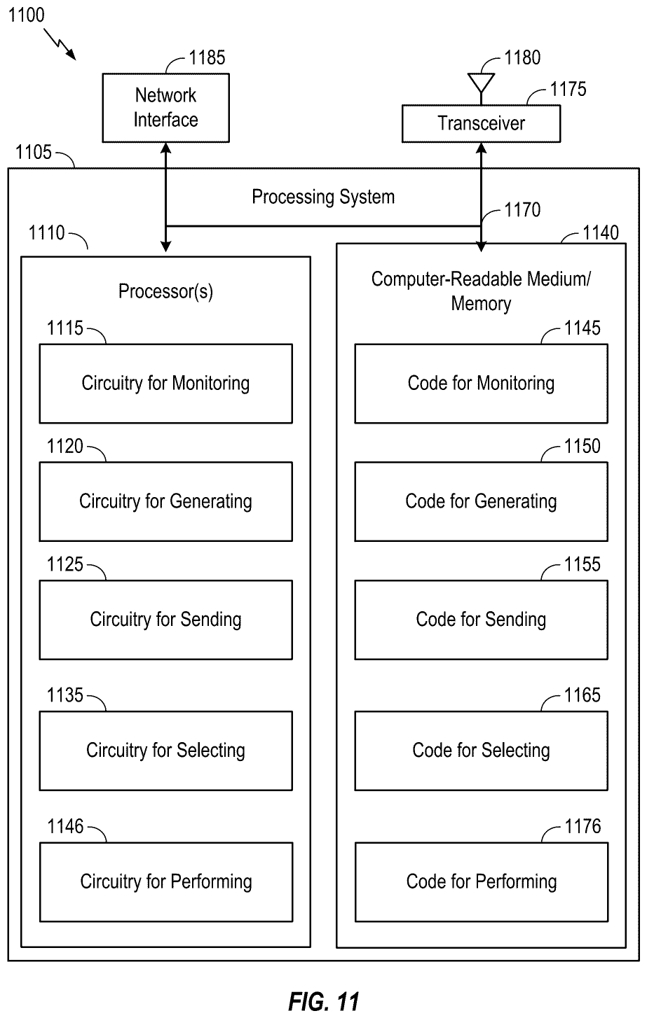

FIG. 11 depicts aspects of an example communications device 1100. In some aspects, communications device 1100 is a controller (e.g., V2G controller, grid controller, modem, or any suitable network connected device).

The communications device 1100 includes a processing system 1105 coupled to the transceiver 1175 (e.g., a transmitter and/or a receiver). In some aspects (e.g., when communications device 1100 is a network entity), processing system 1105 may be coupled to a network interface 1185 that is configured to obtain and send signals for the communications device 1100 via communication link(s), such as a backhaul link, midhaul link, and/or fronthaul link as described herein, such as with respect to FIG. 2. The transceiver 1175 is configured to transmit and receive signals for the communications device 1100 via the antenna 1180, such as the various signals as described herein. The processing system 1105 may be configured to perform processing functions for the communications device 1100, including processing signals received and/or to be transmitted by the communications device 1100.

The processing system 1105 includes one or more processors 1110. In various aspects, the one or more processors 1110 may be representative of one or more of receive processor 358, transmit processor 364, TX MIMO processor 366, and/or controller/processor 380, as described with respect to FIG. 3. In various aspects, one or more processors 1110 may be representative of one or more of receive processor 338, transmit processor 320, TX MIMO processor 330, and/or controller/processor 340, as described with respect to FIG. 3. The one or more processors 1110 are coupled to a computer-readable medium/memory 1140 via a bus 1170. In certain aspects, the computer-readable medium/memory 1140 is configured to store instructions (e.g., computer-executable code) that when executed by the one or more processors 1110, cause the one or more processors 1110 to perform techniques described herein, or any aspect related to it. Note that reference to a processor performing a function of communications device 1100 may include one or more processors 1110 performing that function of communications device 1100.

In the depicted example, computer-readable medium/memory 1140 stores code (e.g., executable instructions), such as code for monitoring 1145, code for generating 1150, code for sending 1155, code for selecting 1165, and code for performing 1176. The one or more processors 1110 include circuitry configured to implement (e.g., execute) the code stored in the computer-readable medium/memory 1140, including circuitry for monitoring 1115, circuitry for generating 1120, circuitry for sending 1125, circuitry for selecting 1135, and circuitry 1146 for performing.

Various components of the communications device 1100 may provide means for performing the methods described herein or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1175 and the antenna 1180 of the communications device 1100 in FIG. 11. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1175 and the antenna 1180 of the communications device 1100 in FIG. 11.

### Example Clauses

Implementation examples are described in the following numbered clauses:

Aspect 1: A method for data communication, comprising: monitoring, via a first device of a vehicle, communications traffic on a power line to receive a first payload originating from a second device of the vehicle and targeted to a third device of the vehicle; generating, via the first device, a data unit including the first payload to relay the first payload to the third device; and sending the data unit on the power line.

Aspect 2: The method of Aspect 1, further comprising generating a second payload to be sent on the power line, wherein the data unit further includes the second payload, and wherein the second payload is targeted to a fourth device different than the third device.

Aspect 3: The method of Aspect 1 or 2, wherein the power line is part of an automobile power line communication (PLC) network.

Aspect 4: The method according to any of Aspects 1-3, wherein the communications traffic on the power line is monitored in response to one or more conditions being met.

Aspect 5: The method of Aspect 4, wherein the one or more conditions comprise: a signal strength on the power line being below a signal strength threshold; a level of congestion associated with the communications traffic on the power line; whether a size of a payload generated by the first device to be included in the data unit is less than a payload size threshold; or a state of the vehicle including the power line.

Aspect 6: The method according to any of Aspects 1-5, wherein: the first payload is one of a plurality of payloads received by the first device; and the method further comprises selecting, from the plurality of payloads, the first payload to be relayed based on one or more conditions associated with the payload.

Aspect 7: The method of Aspect 6, wherein the one or more conditions includes whether a direct path exists between the first device and the second device.

Aspect 8: The method of Aspect 7, wherein the direct path comprises a path that does not pass through a power source.

Aspect 9: The method according to any of Aspects 6-8, further comprising maintaining a list of devices to support for payload relaying, wherein the one or more conditions comprises whether the second device is part of the list of devices.

Aspect 10: The method according to any of Aspects 1-9, wherein the first device is a dedicated relay device.

Aspect 11: The method according to any of Aspects 1-10, wherein the communications traffic on the power line is monitored to further receive a second payload targeted to the third device or a fourth device, the data unit further including the second payload.

Aspect 12: The method of Aspect 11, further comprising performing an exclusive OR (XOR) operation on the first payload and the second payload to yield XOR data, wherein including the first payload and the second payload in the data unit comprises including the XOR data in the data unit.

Aspect 13: The method according to any of Aspects 1-12, further comprising selecting a first robust mode from a plurality of robust modes to send the data unit, the plurality of robust modes being associated with different numbers of code repetitions, wherein the first robust mode has fewer code repetitions than a second robust mode of the plurality of robust modes.

Aspect 14: The method of Aspect 13, wherein the first robust mode is selected based on a quality of a channel on the power line being greater than a threshold.

Aspect 15: An apparatus for data communication, comprising: one or more memories; and one or more processors coupled to the one or more memories and configured to: monitor, via a first device of a vehicle, communications traffic on a power line to receive a first payload originating from a second device of the vehicle and targeted to a third device of the vehicle; generate, via the first device of the vehicle, a data unit including the first payload to relay the first payload to the third device; and send the data unit on the power line.

Aspect 16: The apparatus of Aspect 15, wherein the one or more processors are further configured to generate a second payload to be sent on the power line, wherein the data unit further includes the second payload.

Aspect 17: The apparatus of Aspect 16, wherein the second payload is targeted to a fourth device different than the third device.

Aspect 18: The apparatus according to any of Aspects 15-17, wherein the one or more processors are configured to monitor the communications traffic on the power line in response to one or more conditions being met.

Aspect 19: The apparatus of Aspect 18, wherein the one or more conditions comprise: a signal strength on the power line being below a signal strength threshold; a level of congestion associated with the communications traffic on the power line; whether a size of a payload generated by the first device to be included in the data unit is less than a payload size threshold; or a state of the vehicle including the power line.

Aspect 20: The apparatus according to any of Aspects 15-19, wherein: the first payload is one of a plurality of payloads received by the first device; and the one or more processors are further configured to select, from the plurality of payloads, the first payload to be relayed based on one or more conditions associated with the payload.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, or multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for data communication, comprising:
monitoring, via a first device of a vehicle, communications traffic on a power line to receive a first payload originating from a second device of the vehicle and targeted to a third device of the vehicle;
generating, via the first device, a data unit including the first payload to relay the first payload to the third device; and
sending the data unit on the power line.

2. The method of claim 1, further comprising generating a second payload to be sent on the power line, wherein the data unit further includes the second payload, and wherein the second payload is targeted to a fourth device different than the third device.

3. The method of claim 1, wherein the power line is part of an automobile power line communication (PLC) network.

4. The method of claim 1, wherein the communications traffic on the power line is monitored in response to one or more conditions being met.

5. The method of claim 4, wherein the one or more conditions comprise:
a signal strength on the power line being below a signal strength threshold;
a level of congestion associated with the communications traffic on the power line;
whether a size of a payload generated by the first device to be included in the data unit is less than a payload size threshold; or
a state of the vehicle including the power line.

6. The method of claim 1, wherein:
the first payload is one of a plurality of payloads received by the first device; and
the method further comprises selecting, from the plurality of payloads, the first payload to be relayed based on one or more conditions associated with the payload.

7. The method of claim 6, wherein the one or more conditions includes whether a direct path exists between the first device and the second device.

8. The method of claim 7, wherein the direct path comprises a path that does not pass through a power source.

9. The method of claim 6, further comprising maintaining a list of devices to support for payload relaying, wherein the one or more conditions comprises whether the second device is part of the list of devices.

10. The method of claim 1, wherein the first device is a dedicated relay device.

11. The method of claim 1, wherein the communications traffic on the power line is monitored to further receive a second payload targeted to the third device or a fourth device, the data unit further including the second payload.

12. The method of claim 11, further comprising performing an exclusive OR (XOR) operation on the first payload and the second payload to yield XOR data, wherein including the first payload and the second payload in the data unit comprises including the XOR data in the data unit.

13. The method of claim 1, further comprising selecting a first robust mode from a plurality of robust modes to send the data unit, the plurality of robust modes being associated with different numbers of code repetitions, wherein the first robust mode has fewer code repetitions than a second robust mode of the plurality of robust modes.

14. The method of claim 13, wherein the first robust mode is selected based on a quality of a channel on the power line being greater than a threshold.

15. An apparatus for data communication, comprising:
one or more memories; and
one or more processors coupled to the one or more memories and configured to:
monitor, via a first device of a vehicle, communications traffic on a power line to receive a first payload originating from a second device of the vehicle and targeted to a third device of the vehicle;
generate, via the first device, a data unit including the first payload to relay the first payload to the third device; and
send the data unit on the power line.

16. The apparatus of claim 15, wherein the one or more processors are further configured to generate a second payload to be sent on the power line, wherein the data unit further includes the second payload.

17. The apparatus of claim 16, wherein the second payload is targeted to a fourth device different than the third device.

18. The apparatus of claim 15, wherein the one or more processors are configured to monitor the communications traffic on the power line in response to one or more conditions being met.

19. The apparatus of claim 18, wherein the one or more conditions comprise:
a signal strength on the power line being below a signal strength threshold;
a level of congestion associated with the communications traffic on the power line;
whether a size of a payload generated by the first device to be included in the data unit is less than a payload size threshold; or
a state of the vehicle including the power line.

20. The apparatus of claim 15, wherein:
the first payload is one of a plurality of payloads received by the first device; and
the one or more processors are further configured to select, from the plurality of payloads, the first payload to be relayed based on one or more conditions associated with the payload.
